(19) United States
(12) Patent Application Publication
(10) Pub. No.: US 2026/0002091 A1
(43) Pub. Date: Jan. 1, 2026

(54) SYSTEM AND METHOD FOR FATTY ACID PURIFICATION AND/OR LIPID MANUFACTURE

(71) Applicant: Savor Foods Limited, San Jose, CA (US)

(72) Inventors: Trevor Seidel, San Jose, CA (US); Evan Roberts, San Jose, CA (US); Nikifar Lazouski, San Jose, CA (US)

(73) Assignee: Savor Foods Limited, San Jose, CA (US)

(21) Appl. No.: 19/257,210

(22) Filed: Jul. 1, 2025

Related U.S. Application Data
(60) Provisional application No. 63/666,448, filed on Jul. 1, 2024.

(51) Int. Cl. C11C 3/12; C11C 1/02; C11C 1/08; C11C 3/00

(52) U.S. Cl. CPC C11C 3/12; C11C 1/025; C11C 1/08; C11C 3/006

(57) ABSTRACT

A method can include oxidizing hydrocarbons (and optionally oxygenates with oxygenation states less than carboxylic acids such as alcohols, aldehydes, etc.), separating the oxygenated hydrocarbons into saponifiable species and nonsaponifiable species, and treating the saponifiable species (e.g., heat treating, hydrogenation, etc. such as to reduce unsaturated bonds to saturated bonds, to convert oxygenates with greater degrees of oxygenation than monocarboxylic acids into monocarboxylic acids, etc.).

### CROSS-REFERENCE TO RELATED APPLICATIONS

This application claims the benefit of U.S. Provisional Application No. 63/666,448 filed 1 Jul. 2024, which is incorporated in its entirety by this reference.

### TECHNICAL FIELD

This invention relates generally to the fatty acid field, and more specifically to a new and useful system and method in the fatty acid field.

### BRIEF DESCRIPTION OF THE FIGURES

FIG. 1 is a schematic representation of the method.

FIG. 2 is a schematic representation of a variant of the method.

FIGS. 3A and 3B are exemplary tables of exemplary sample compositions before and after a soap cooking (e.g., thermal treatment of carboxylates and other species) step (e.g., after redissolving the soap in water).

FIG. 3C is an exemplary tables of exemplary sample compositions (excluding solvents) before saponification (and/or before solvent extractions or phase separations subsequent to saponification), after separations (e.g., evaporation, multi-stage evaporations, etc. and before thermal treatment), and after a soap cooking step (e.g., after thermally treating soaps). In this table, carbonyls can include ketones and/or aldehydes; carboxylates can include carboxylic acids or deprotonated carboxylic acids (but does not include deprotonated hydroxyacids, deprotonated ketoacids, etc.); and polyhydroxyl/polycarbonyl/etc. can include diols, triols, polyols, dicarbonyls (e.g., diketone, dialdehydes, ketoaldehydes), tricarbonyls, polycarbonyls, ketoacids, and other oxygenates with a plurality of carbon atoms bonded to oxygen atoms (via single and/or double bonds) and/or oxygen atoms bonded to other oxygen atoms (e.g., peroxides).

FIGS. 4A and 4B are schematic representations of examples of soap cooking.

FIG. 5 is a schematic representation of an exemplary plug flow reactor.

FIG. 6 is a schematic representation of an example of in situ hydrogenation during soap cooking.

FIG. 7 is a schematic representation of an example of in situ introduction of carbon dioxide during soap cooking (e.g., to suppress decarboxylation reaction(s), enable higher temperature soap cooking, etc.).

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

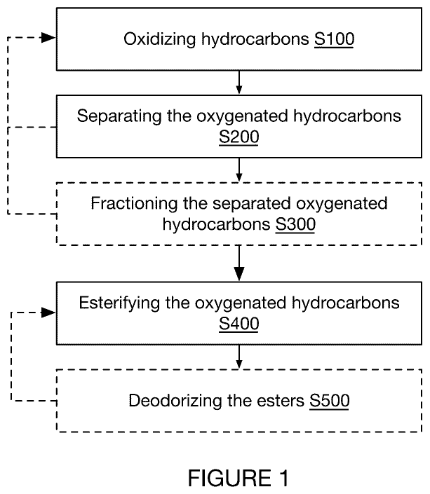

As shown in FIG. 1, the method can include oxidizing hydrocarbons S100, separating the oxygenated hydrocarbons S200, and esterifying the oxygenated hydrocarbons S400. The method can optionally include fractioning the separated oxygenated hydrocarbons S300, deodorizing the esters S500, and/or any suitable step(s).

The method preferably functions to make (e.g., synthesize, manufacture, produce, etc.) a glyceride (e.g., triglyceride, 1- or 2-monoglyceride, 1,2- or 1,3-diglyceride, etc.) composition which can be used, for example, as a substitute or artificial fat in food products, a baking or cooking oil (e.g., frying oil), a soap, a lubricant, a surfactant, detergent, emulsifier, texturizing agent, wetting agent, anti-foaming agent, stabilizing agent, emollient, metal working fluid, water treatment, varnish or other surface treatment, in personal care or cosmetic products (e.g., in lip balm, lotion, etc.), and/or can be used for any suitable purpose. The method can additionally or alternatively function to make free fatty acid(s) and/or any suitable composition. The fatty acids (e.g., making up the glyceride(s)) are preferably saturated, but can be unsaturated, aromatic, cyclic and/or have any suitable structure. The fatty acids are preferably straight chain (e.g., unbranched), but can be branched and/or have any suitable structure. The glycerides can be chiral and/or achiral. In specific examples, the fatty acids and/or glycerides can be used in a formulation such as to form a lipid formulation as described in U.S. patent application Ser. No. 18/210,207 titled ‘FAT FORMULATIONS’ filed 15 Jun. 2023, U.S. patent application Ser. No. 18/428,575 titled ‘MILKFAT OR BUTTERFAT FORMULATIONS’ filed 31 Jan. 2024, U.S. patent application Ser. No. 18/619,539 titled ‘FAT FORMULATIONS’ filed 28 Mar. 2024, U.S. patent application Ser. No. 18/818,047 titled ‘LIQUID OR SEMI-SOLID FAT FORMULATIONS’ filed 28 Aug. 2024, and/or U.S. patent application Ser. No. 18/974,401 titled ‘FAT COMPOSITION AND RELATIONSHIP WITH FREE FATTY ACID DISTRIBUTION’ filed 9 Dec. 2024, each of which is incorporated in its entirety by this reference.

The fatty acids (and/or glycerides) can be used, for example, to produce a fat composition (e.g., fat formulation), where the fat composition can be used as a fat in food products (e.g., as a nutritional supplement such as for baby formula, for nutritional bars, for drinks, etc.; a performance additive such as for stabilizing nut butters, seed butters, etc.; a fat source in plant based products such as a fat included in a plant-based yogurt, plant-based cheese, etc.; etc.), a baking or cooking oil (e.g., frying oil such as for French fries, meat products, vegetables, party items, etc.; fat for baked goods, confections, chocolate, ice cream, etc.; cooking spray or otherwise prepare a nonstick or low-stick cooking or baking surface; etc.), sauces (e.g., dips, dressings, condiments, etc.), a soap, a lubricant, creamer (e.g., coffee creamer), a surfactant, detergent, emulsifier, texturizing agent, wetting agent, anti-foaming agent, stabilizing agent, emollient, metal working fluid, water treatment, varnish or other surface treatment, in personal care or cosmetic products (e.g., in lip balm, lotions, make-up, moisturizers, perfumes, lipstick, nail polish, shampoo, colorant, deodorants, essential oil, massage oil, soap, etc.), aromatherapy, and/or can be used for any suitable purpose. For example, the formulation can be a food grade (e.g., generally recognized as safe (GRAS) for consumption) fat replacement for one or more of the following fats: lard (e.g., leaf lard), tallow (e.g., beef tallow, mutton tallow, lamb tallow, bison tallow, etc.), tail fat, poultry fat (e.g., duck fat, goose fat, chicken fat, turkey fat, foie gras, etc.), schmaltz (e.g., clarified chicken fat, clarified goose fat, clarified duck fat, etc.), dripping (e.g., beef dripping, pork dripping, etc.), suet, fish oil (e.g., sardine oil, herring oil, anchovy oil, salmon oil, trout oil, tuna oil, swordfish oil, mackerel oil, cod liver oil, shark liver oil, etc.), blubber (e.g., whale fat, seal fat, etc.), Bovidae fat (e.g., bison fat, water buffalo fat, cattle fat, yak fat), Camelidae fat (e.g., dromedary fat, llama fat, etc.), Capra fat (e.g., goat fat, goat milkfat, etc.), Cervidae fat (e.g., elk fat, fallow deer fat, moose fat, red deer fat, reindeer fat, white-tailed deer fat, etc.), Equidae fat (e.g., donkey fat, horse fat, etc.), Lagomorph fat (e.g., rabbit fat), Macropodidae fat (e.g., kangaroo fat), Ovis fat (e.g., sheep fat, lamb fat, mutton fat, sheep milkfat, etc.), Suidae fat (e.g., pig fat, boar fat, etc.), amphibian fat (e.g., frog fat, salamander fat, etc.), bird fat (e.g., chicken fat, duck fat, goose fat, turkey fat, quail fat, pigeon fat, guineafowl fat, ostrich fat, emu fat, peacock fat, egg fat, etc.), crustacean fat (e.g., crayfish fat, crab fat, lobster fat, shrimp fat, prawn fat, etc.), mollusk fat (e.g., oyster fat, mussel fat snail fat, abalone fat, etc.), reptile fat (e.g., alligator fat, crocodile fat, turtle fat, etc.), game fat (e.g., bushmeat fat, antelope fat, porcupine fat, cane rat fat, elephant fat, snake fat, rattle snake fat, caribou fat, hare fat, opossum fat, bear fat, deer fat, etc.), simian fat, canine fat, feline fat, shortening, milkfat or butterfat (e.g., cow milk, goat milk, sheep milk, yak milk, buffalo milk, etc. such as for milk, cream, hard cheese, soft cheese, spreadable cheese, melting cheese, processed cheese, vegan cheese, etc.), ghee (e.g., clarified butter), intramuscular fat or marbling replacement (e.g., for beef, for pork, for buffalo, for mutton, for sheep, for veal, for goat, for yak, for poultry, etc.), intermuscular fat replacement (e.g., for beef, for pork, for buffalo, for mutton, for sheep, for veal, for goat, for yak, for poultry, etc.), subcutaneous fat replacement (e.g., for beef, for pork, for buffalo, for mutton, for sheep, for veal, for goat, for yak, for poultry, etc.), vegetable oil (e.g., cocoa butter, shea butter, coconut oil, coconut butter, coconut milk, coconut cream, palm oil, hydrogenated palm oil, palm kernel oil, mango butter, Borneo tallow, seed oils, nut oils, coffee oil, tea tree oil, vegetable shortening, etc.), and/or for any suitable fat replacement (e.g., a vegan fat replacement, a vegetarian fat replacement, a kosher fat replacement, a halal fat replacement, a vegan animal fat mimic, a vegetarian animal fat mimic, a kosher animal fat mimic such as a substitute for pork fat that is kosher, a halal animal fat mimic such as a substitute for pork fat that is halal, etc.). In some specific examples, the fatty acids (e.g., carboxylates) can be used in a fat formulation as described in U.S. patent application Ser. No. 18/428,575 titled ‘MILKFAT OR BUTTERFAT FORMULATIONS’ filed 31 Jan. 2024, U.S. patent application Ser. No. 18/619,539 titled ‘FAT FORMULATIONS’ filed 28 Mar. 2024, U.S. patent application Ser. No. 18/818,047 titled ‘LIQUID OR SEMI-SOLID FAT FORMULATIONS’ filed 28 Aug. 2024, and/or U.S. patent application Ser. No. 18/974,401 titled ‘FAT COMPOSITION AND RELATIONSHIP WITH FREE FATTY ACID DISTRIBUTION’ filed 9 Dec. 2024, each of which is incorporated in its entirety by this reference.

### 2. Benefits

Variations of the technology can confer several benefits and/or advantages.

First, variants of the technology can be beneficial for producing fatty acids (and/or derivatives thereof) with a low carbon intensity (e.g., without the use of agriculture). For example, by using inorganic carbon feedstocks (e.g., carbon dioxide, carbon monoxide, methane, ethane, ethene, ethyne, coal, etc.), fatty acids can be manufactured without requiring animals, plants, or other living organisms. This can lead to lower land-use, less water use, enhanced energy efficiency, and/or can otherwise facilitate a low carbon intensity (e.g., small carbon footprint).

Second, variants of the technology can enable economical production of fatty acids (e.g., while maintaining or achieving a low carbon intensity, without the use of agriculture, etc.).

Third, variants of the technology can decrease the quantity of oxygenated species, particularly (but not exclusively) those that can impart undesirable gustatory, olfactory, organoleptic, health, safety, and/or other properties to a formulation (e.g., for a food product) using fatty acids and/or glycerides derived therefrom. For instance, the use of soap cooking can be beneficial for decreasing the amount of lactones, hydroxyacids, ketoacids, and/or other non-carboxylic acid species. In some examples, the carboxylic acids can be concentrated as lactones and hydroxyacids can be converted into carboxylic acids by variations of the method. However, any suitable processes can be used to separate or remove oxygenated species.

However, variants of the technology can confer any other suitable benefits and/or advantages.

### 3. Method

As shown in FIG. 1, the method can include oxidizing hydrocarbons S100, separating the oxygenated hydrocarbons S200, and esterifying the oxygenated hydrocarbons S400. The method can optionally include fractioning the separated oxygenated hydrocarbons S300, deodorizing the esters S500, and/or any suitable step(s).

The method can be performed in a single-pot synthesis or a multi-pot synthesis. The method can be performed at a laboratory scale (e.g., ranging from producing and/or consuming masses of products or reactants between about 1 ng and 1 g), process scale (e.g., 1 g to 1 kg), bench scale (e.g., 1 kg to 100 kg), demonstration scale (e.g., greater than 100 kg), and/or on any suitable scale. The method (and/or steps thereof) can be performed in a batch reactor, continuous stirred-tank reactor, plug flow reactor, semi-batch reactor, catalytic reactor, and/or in any suitable tank, manifold (e.g., pipe, tube, etc.), and/or chemical reactor. The method and/or steps thereof can be performed in a batch process, a continuous process, and/or in any suitable process.

For instance, in some variants of the method, between 1 kg/hr and 1000 kg/hr of hydrocarbons (e.g., starting with S100) and/or oxygenates (e.g., starting with S200 processes) can be handled and/or treated.

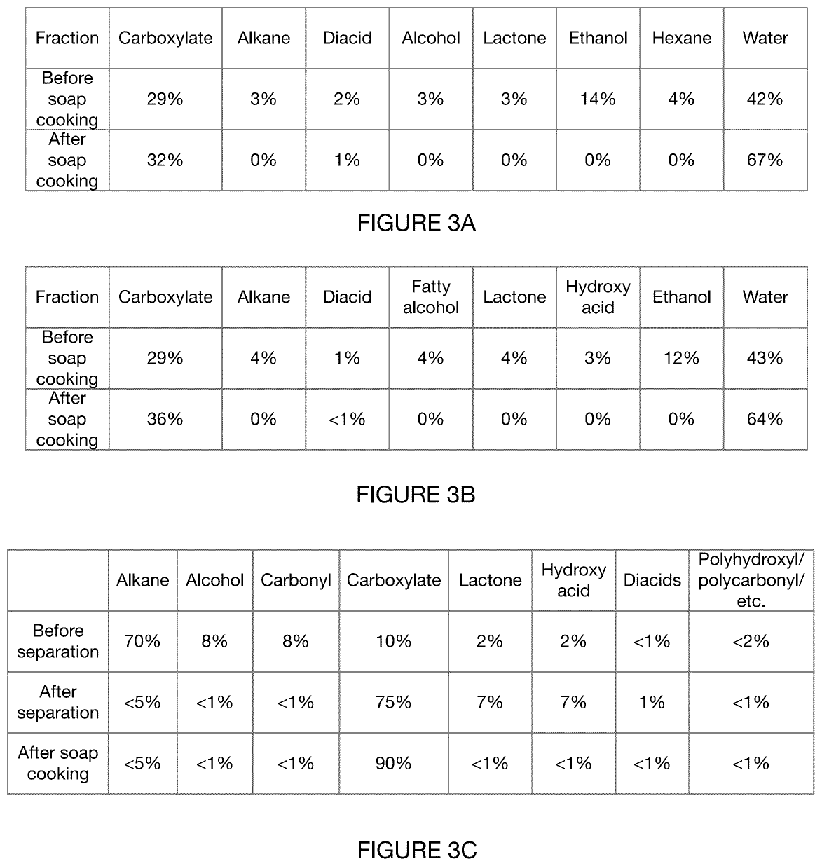

Oxidizing the hydrocarbon sample S100 functions to form oxygenated hydrocarbons. The oxygenated hydrocarbons are preferably monocarboxylic acids but typically include other oxygenated (by) products such as: alcohols, ketones, aldehydes, polycarboxylic acids (e.g., diacids), cyclic esters (e.g., lactones), oxoacids (e.g., ketoacids), hydroxyacids (e.g., including a hydroxyl moiety and a carboxylic acid moiety), acid anhydrides, ethers, and/or other related species. As one specific example (as shown for instance in FIG. 3C), a composition of the oxygenated hydrocarbons can include about 70% (e.g., 60-80%) hydrocarbons (e.g., hydrocarbons that are not oxidized or do not undergo reactions during S100), about 10% (e.g., 5-15%) alcohols, about 10% (e.g., 5-15%) carbonyls (e.g., monoaldehydes, monoketones), about 10% carboxylates (e.g., monocarboxylates, carboxylic acids), about 1% (e.g., 0.1-3%) lactones, about 1% (e.g., 0.1-3%) hydroxyacids, about 1% (e.g., 0.1-1.5%) diacids, and trace amounts of other oxygenates (e.g., alcohols including more than one hydroxyl group, carbonyls including more than one carbonyl group, ketoacids, organic compounds with one or more hydroxyl and carbonyl group, organic compounds with two or more hydroxyl and carboxylate groups, etc.). The hydrocarbon sample can be oxidized in the same or a different reactor from a reactor used for the formation of the hydrocarbon sample.

The hydrocarbon sample to be oxidized can include hydrocarbons (e.g., mined hydrocarbons, recovered hydrocarbons, hydrocarbons formed from a Fischer-Tropsch synthesis, etc.), oxygenated hydrocarbons (e.g., from a Ziegler process; from prior instances of oxidizing hydrocarbons such as recycled from S200, S300, S400, S500, etc.; etc.), processed hydrocarbons, synthesized hydrocarbons, received hydrocarbons, and/or any suitable species. In some variants, the hydrocarbon sample can include up to 100% (e.g., 10%, 20%, 30%, 40%, 50%, 60%, 70%, 80%, 90%, values or ranges therebetween, etc.) recycled hydrocarbons (e.g., hydrocarbons or partially-oxygenated hydrocarbons from previous oxidation processes). For example, a straight-chain paraffin sample can be oxidized. The hydrocarbon sample preferably includes hydrocarbons with chain lengths between about 6 and 100 carbon atoms. However, the hydrocarbon sample can additionally or alternatively include hydrocarbons with a chain length shorter than 6 carbon atoms and/or longer than 100 carbon atoms. In an illustrative example, the hydrocarbon sample can include hydrocarbons with chain lengths between about 18 and 28 (e.g., a peak of a chain length distribution of the hydrocarbons can be between 18 and 28 carbon atoms, at least 90% of the hydrocarbon sample can be hydrocarbons with a chain length between 18 and 28 carbon atoms, etc.).

In some variations, oxidizing the hydrocarbon sample can additionally or alternatively function to modify (e.g., decrease) a distribution of chain lengths of the hydrocarbon sample (e.g., decrease an average chain length, decrease a most common chain length, etc.) and/or can otherwise function. In these variations, the oxidation process can broaden the chain length distribution (e.g., produce a larger range of chain sizes in the oxygenated hydrocarbons than in the hydrocarbon sample, increase a standard deviation, etc.), and/or not change the chain length distribution deviation. For example, after the oxidation reaction, the oxidized hydrocarbons can include oxygenated hydrocarbons with between about 2 and 24 carbon atoms. However, the oxygenated hydrocarbons can include any suitable number of carbon atoms.

In one illustrative example, S100 can include oxidizing hydrocarbons in a manner as described in U.S. patent application Ser. No. 17/825,490 titled ‘SYSTEM AND METHOD FOR PRODUCTION OF SYNTHETIC FATTY ACIDS’ filed 26 May 2022, which is incorporated in its entirety by this reference. However, any suitable hydrocarbon sample can be oxidized.

The oxidation conditions used for oxidizing the hydrocarbons preferably avoid overoxidizing the hydrocarbons. For instance, the conditions are preferably selected to form alcohols (e.g., primary alcohols, monohydric alcohols, etc.), aldehydes (e.g., monoaldehydes), monocarboxylic acids, and/or other oxygenated species where a single carbon atom in the chain (e.g., preferably but not necessarily a primary or terminal carbon atom) is bonded to an oxygen atom. Similarly, the conditions are preferably selected to avoid formation of polyhydric alcohols, ketones, polycarboxylic acids, lactones, and/or other oxygenated species where a plurality of carbon atoms are bonded to oxygen and/or a secondary (or higher order) carbon atom is bonded to an oxygen atom. As a result, the oxidation reaction is frequently incomplete and some (e.g., 5%, 10%, 20%, 30%, 40%, 50%, 60%, 70%, 80%, 90%, 95%, values or ranges therebetween etc.) of the initial hydrocarbons can remain unreacted. These unreacted hydrocarbons can then be recycled (e.g., have S100 performed on them again, be mixed with a second hydrocarbon sample that is to be oxidized, gasified, etc.), discarded, and/or can otherwise be used. Similarly, underoxidized species (e.g., aldehydes, primary alcohols, etc.) can be recycled in the oxidation reaction, can be reduced (e.g., via gasification to form carbon feedstock), and/or can otherwise be recycled and/or used. Overoxidized species (e.g., ketones, polyhydric alcohols, secondary alcohols, tertiary alcohols, lactones, etc.) can be reduced (e.g., via hydrogenation) where the reduced species can be oxidized again, can be gasified (e.g., to form carbon feedstock), and/or can otherwise be used.

Examples of process parameters that can be tuned to modify the resulting oxygenated hydrocarbon composition in some variants of S100 can include: oxidation time, oxidation temperature, oxidation catalyst (e.g., permanganate such as potassium permanganate, iron catalyst, copper catalyst, phenacylamine catalyst, fat-soluble catalyst such as manganese soaps, etc.), oxidation flow rate, oxygen concentration, oxidation pressure, mixing rate, and/or any suitable process parameters can be used.

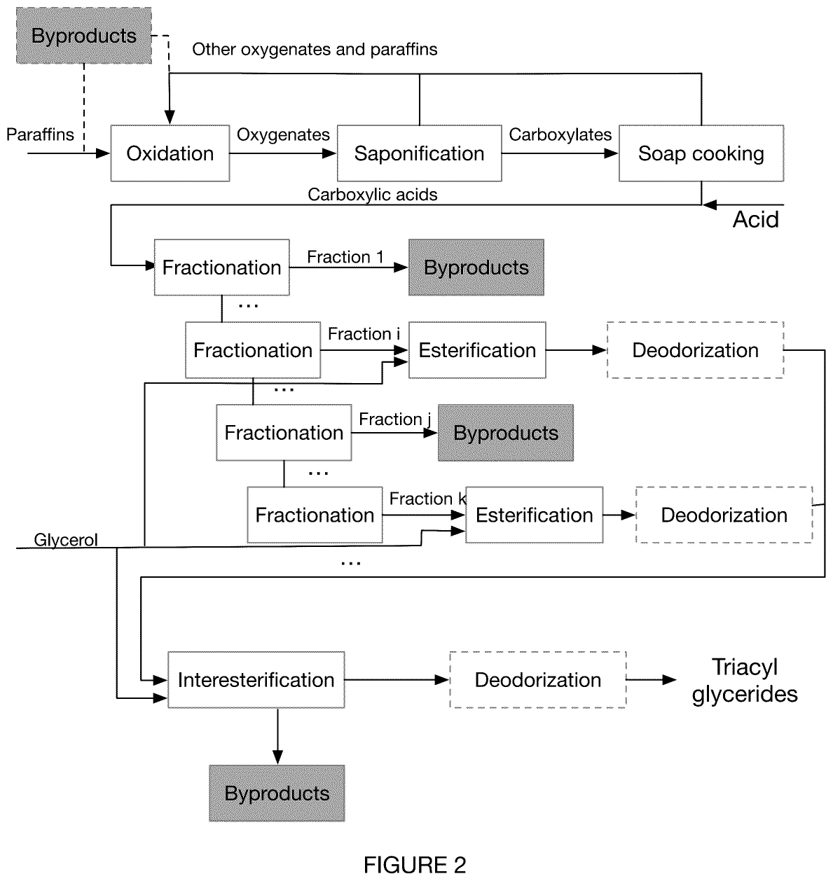

The hydrocarbon sample can be oxidized at a temperature between about 90-400° (e.g., 90-150° C.). However, in some variants, the hydrocarbon sample can be oxidized at a temperature less than 90° C. or greater than 400° C. The hydrocarbon sample can be oxidized at a pressure between about 1 and 25 bar. However, in some variants, the hydrocarbon sample can be oxidized at a pressure less than 1 bar and/or greater than 25 bar. The hydrocarbon sample can be oxidizing using air, oxygen (e.g., pure oxygen such as oxygen with a purity of 90%, 95%, 97%, 98%, 99%, 99.5%, 99.9%, 99.95%, 99.99%, 99.995%, 99.999%, 99.9999%, 100%, etc.), and/or any suitable oxygen source can be used. The flow rate (e.g., of the oxygen component of the oxidant) is preferably between 10 sccm/20 gram hydrocarbon and 1000 sccm/20 gram hydrocarbon (e.g., 10 sccm/20 gram hydrocarbon, 20 sccm/20 gram hydrocarbon, 40 sccm/20 gram hydrocarbon, 50 sccm/20 gram hydrocarbon, 100 sccm/20 gram hydrocarbon, 200 sccm/20 gram hydrocarbon, 400 sccm/20 gram hydrocarbon, 500 sccm/20 gram hydrocarbon, 1000 sccm/20 gram hydrocarbon, values or ranges therebetween, etc.) but can be less than 10 sccm/20 gram hydrocarbon or greater than 1000 sccm/20 gram hydrocarbon. For example, when air is used to oxidize the hydrocarbon sample, a flow rate can be about 200 sccm/20 gram hydrocarbon. The hydrocarbon sample is preferably rigorously stirred during oxidation (e.g., using mechanical impellers, vigorous bubbling, etc.). Separating the oxidized hydrocarbons S200 can function to separate byproducts or other undesirable species (e.g., partially oxidized hydrocarbons, overoxidized hydrocarbons, etc.) from the carboxylic acids. For example (e.g., as shown for instance in FIG. 2), carboxylic acids (e.g., fatty acids) can be separated from unoxidized hydrocarbons (e.g., paraffins) and/or other oxygenated hydrocarbons (e.g., alcohols, aldehydes, ketones, lactones, polycarboxylic acids, esters, etc.) which can be beneficial for recycling species (e.g., to improve an overall yield), to isolate fatty acids, and/or can otherwise be beneficial.

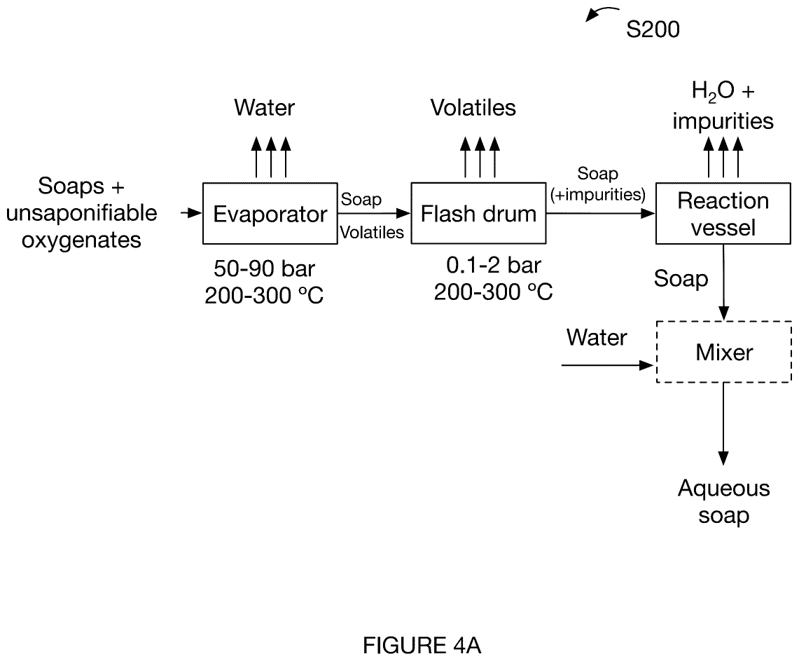

S200 preferably includes saponification of the oxidized hydrocarbons S220 (e.g., deprotonation of carboxyl moieties), separating unsaponified (or unsaponifiable) species from the soap (saponified species) S230, heat treating (thermal treating) the soap S250 (e.g., carboxylate salts), and acidulation of the soap S280. However, S200 can additionally or alternatively include other suitable steps and/or processes (e.g., fatty acid esterification (FAE) fractionation, solvent extraction, sorbents, urea complexation, crystallization, chromatography, distillation, centrifugation, separation techniques as described in U.S. Provisional Application 63/533,007 titled ‘SYSTEM AND METHOD FOR TRIGLYCERIDE MANUFACTURE’ filed 16 Aug. 2023 which is incorporated in its entirety by this reference, etc.). In a specific example, as shown for instance in FIG. 4, S200 can include a high-pressure evaporation step S233 (e.g., performed in an evaporator), a low pressure evaporation step S237 (e.g., performed in a flash drum), a dehydration step S250 (e.g., performed in a reaction vessel, continuous stirred tank reactor, plug flow reactor, etc.), a mixing step S255 (e.g., performed in a static mixer), and/or any suitable step(s).

Saponification of the oxidized hydrocarbons S220 preferably functions to convert the carboxylic acids to carboxylates (e.g., carboxylate salts). As the resulting carboxylate salts are ionic, they typically have different solubility, vapor pressure (and/or related boiling points), and/or electrostatic properties and can be separated from other (e.g., neutral) oxygenated hydrocarbons. For instance, the carboxylate salts can be partitioned into an aqueous phase while other species partition into an organic phase and can be removed (e.g., via decanting or other physical separation processes). In some variants, one or more organic solvents (e.g., ethanol, methanol, hexane, isopropyl alcohol, pentane, heptane, octane, etc.) can be used to facilitate the partitioning of species. In one specific example, hexane can be used to phase separate the saponified material from unsaponified (or unsaponifiable) material. In a second specific example, water and/or ethanol can be used to phase separate the saponified material from unsaponified or unsaponifiable material (e.g., without performing or using hexane or other hydrocarbon(s) for a washing or extraction step).

S220 preferably does not substantially change other oxygenated hydrocarbons (e.g., less than 10% of alcohols are deprotonated, less than 10% of ketones and aldehydes are converted to ketals or acetals, etc.), which can facilitate separation of the neutral species from the carboxylates. However, other oxygenated species (particularly but not exclusively hydroxyacids, ketoacids, lactones) can be deprotonated or otherwise react (e.g., lactones being converted to hydroxyacids which can subsequently be deprotonated).

Saponification can be performed, for instance, by mixing the oxidized hydrocarbons with a base (e.g., alkali metal hydroxide, alkaline earth metal hydroxide, alkali metal, etc.). The base is preferably added in a substoichiometric amount (e.g., less than 1 mol of base per mol of carboxylic acid such as 0.5 mol base/mol acid, 0.75 mol base/mol acid, 0.9 mol base/mol acid, 0.95 mol base/mol acid, 0.99 mol base/mol acid, etc.). However, the base can be added in stoichiometric ratio and/or superstoichiometric ratio (e.g., greater than 1 mol base/mol acid). The saponification can be performed at an elevated temperature (e.g., between about 30-200° C. such as 50° C., 75° C., 100° C., 120° C., 150° C., 180° C., etc.), at or near room temperature (e.g., 0° C.-30° C.), and/or at any suitable temperature (e.g., >120° C., <0° C.). The saponification is typically performed at or near atmospheric pressures (e.g., 0.8-1.1 Bar). In some variants, however, the saponification can be performed at an elevated pressure (e.g., up to about 10 Bar), which can provide a technical advantage of enabling an operation to be performed at greater temperatures (e.g., without boiling the saponified and/or unsaponified material).

The dry component of the soap (i.e., the composition of the soap and/or saponified sample excluding water or other solvents) resulting from S220 (e.g., after collecting the carboxylates) is preferably at most 20% (e.g., by mass, by volume, etc.) neutral (e.g., unsaponifiable, unsaponified, etc.) species (e.g., where the remainder of the dry component is carboxylates or other charged species). However, in some variants, the soap can include higher levels of neutral species. The neutral species are preferably volatile (e.g., alcohols, ketones, hydroxyacids, ketoacids, lactones, monocarboxylic acids, dicarboxylic acids, etc. with carbon chains less than or equal to about, 20, 22, 28, etc. carbon atoms; solvents such as ethanol, hexane, etc.; etc.). However, the neutral species may be nonvolatile (in such situations, the species are typically separated during downstream fractionation or other separation steps). The soap resulting from S220 is typically wet (e.g., includes water). For instance, the soap can be up to about 70% water (e.g., by mass, by volume, by stoichiometric ratio, etc.). However, the soap can be dry (e.g., using alkali metal to directly react with an oxygenated hydrocarbon sample).

Prior to soap cooking and/or further separation steps (e.g., S230, S250, S280, etc.), the bulk of the neutral species (e.g., greater than about 50 wt %, 60 wt %, 75 wt %, 80 wt %, 90 wt %, 95 wt %, etc. of the neutral species) are preferably removed from the saponified species. For instance, the neutral and ionized species (e.g., soap, carboxylates, etc.) can be separated in a settling vessel (allowing the species to phase separate and then decanting or otherwise separating the majority of one phase from the other). Typically some neutral or unsaponified species will remain with the saponified species, but performing this separation can be advantageous for decreasing the amount of unsaponified species to be removed in further processing steps.

Separating unsaponified (or unsaponifiable) species from the soap (saponified species) S230 functions to remove a significant portion of the solvent (e.g., used for transporting the soap, used to phase segregate the soap, etc.) and/or other unsaponifiable species (e.g., fatty alcohols, fatty aldehydes, fatty ketones, hydrocarbons, etc.) from the saponified species (e.g., carboxylates). S230 is typically performed at a temperature above a melting point of the saponified sample (so that the saponified species remain in a molten or liquid state and thus are easier to transport and/or work with). However, S230 could be performed at a lower temperature (e.g., where excess solvent is removed during the thermal treatment).

Separating (e.g., removing) unsaponifiable (or unsaponified) species S230 is typically performed in a series of stepwise processes (e.g., at a plurality of different pressures where each step is typically, but not necessarily, associated with a distinct reactor). However, S230 can be performed in a single step (e.g., a high-pressure step to remove solvent, a low-pressure step for an extended period of time that will remove solvent and unsaponifiable species, etc.) and/or in any suitable steps. When a multi-step process is used, the steps are preferably performed continuously (e.g., species from one step are continuously fed into a subsequent step). However, the steps can additionally or alternatively be performed in batches and/or a subset of steps can be performed continuously while another subset are performed in batches.

Each step of a multistep process can be performed for a target amount of time, until target conditions are met, until target properties (e.g., sensor readings occur), and/or until other suitable conditions occur. For instance, a step of the multistep process can be performed until a pressure swing is observed in a reactor (e.g., indicating that one or more species is substantially fully removed). As another example, a step of the multistep process can be performed until a temperature (for a given pressure) changes by a threshold amount. However, other suitable targets can be set and/or used (e.g., mass or quantity of species detected at an outlet or trap of the evaporator, species detected in an aliquot or sampled at an outlet of the reactor, etc.).

In variants that include a high-pressure evaporation step (e.g., performed in an evaporator), the high-pressure evaporation step preferably functions to reduce a solvent content (e.g., water, ethanol, liquid hydrocarbons under standard temperature and pressure such as pentane or hexane, etc.) in the soap. For instance, a high-pressure evaporation step can reduce a water content by between 70% and 90% (e.g., for every 100 g of water starting in the soap sample, after the high-pressure evaporation step only between 30 g and 10 g of water can remain in the soap sample). The high-pressure evaporation step is preferably performed at a pressure less than the vapor pressure of water for a given temperature. As an illustrative example, when the evaporation temperature is 350° C., the high-pressure evaporation step is preferably performed at a pressure less than about 165 Bar (e.g., 50 Bar, 75 Bar, 80 Bar, 90 Bar, 100 Bar, 120 Bar, 140 Bar, 150 Bar, 160 Bar, etc.). However, other pressure thresholds can be determined (e.g., for different temperatures, for different target evaporation times, for different soap sample sizes, different soap water content, etc.). Volatile species (e.g., other than the solvent(s)) are typically not substantially removed from the soap sample during this step. However, volatile species can be removed by this process.

In variants that include a low-pressure evaporation step (e.g., performed in a flash drum that can include a filter, demister pad, mist eliminator, vapor pad, or other component to capture condensates such as aerosolized soaps thereby preventing the condensates from continuing in the vapor stream), the low-pressure evaporation step preferably functions to reduce a residual water content (e.g., water remaining after a high-pressure evaporation) and/or volatile species (e.g., fatty alcohols, fatty aldehydes, fatty ketones, hydrocarbons, etc. with a carbon chain length less than about 25 carbon atoms long; organic solvent such as ethanol, hexane, etc. from upstream processes; etc.) in the soap (e.g., saponified sample, carboxylates, etc.). The low-pressure evaporation is preferably performed at a pressure between about 0.01 Bar and 50 Bar (e.g., 0.05 Bar, 0.1 Bar, 0.5 Bar, 0.7 Bar, 1 Bar, 1.5 Bar, 2 Bar, 4 Bar, 5 Bar, 7 Bar, 10 Bar, 15 Bar, 20 Bar, 25 Bar, 30 Bar, 40 Bar, 45 Bar, etc.). The low-pressure evaporation is typically performed after a high-pressure evaporation step. As such, the low-pressure evaporation can result in a significant reduction in the temperature of the soap as the soap is transferred from the high pressure to the low pressure. In some variations, a heating element can be included between the low-pressure evaporation and the high-pressure evaporation to raise the temperature between the steps (and/or to otherwise maintain a temperature of the soap between steps). Preferably, the low-pressure is selected such that the soap sample remains liquid after the material evaporation and volume expansion. As an illustrative example, when the low-pressure evaporation is performed at about 2 Bar a soap sample at an initial temperature of 350° C. (e.g., when introduced to 2 Bar pressure from about 70 Bar) can drop in temperature to about 280° C. However, the exact temperature drop can depend on the concentration of water and/or other volatile species, the pressure difference, the soap sample volume, and/or other suitable properties.

In some variations, the high-pressure and/or low-pressure evaporation steps can be excluded (e.g., only high-pressure evaporation performed, only low-pressure evaporation performed, evaporation occurs during dehydration, etc.). As an example of such a variation, a 1-pot reaction system (e.g., under vacuum) can be used for the evaporation step. In this example, a high temperature and/or pressure soap feed can be injected into the 1-pot reaction system, leading to water evaporation (e.g., effectively making powdered soaps, where the 1-pot reaction system can be a spray drier). The powdered soaps can then be heated up (e.g., to a thermal treatment temperature such as 350° C.), maintained at the treatment temperature for a residence time, and can subsequently be acidulated or redissolved (e.g., pumped into a separate reactor, mixer, etc.). This example can provide technical advantages as the spray-drying vessel doesn't have to be a high-pressure vessel, the spray-drying vessel can enable operation as a 1-pot reaction system, and/or the spray-drying vessel can remove some of the unsaponifiable volatiles in the soap (e.g., during the injection process).

In one specific example (as shown for example in FIG. 3C), after S230 a saponified sample composition can include <5% hydrocarbons, <1% alcohols, <1% carbonyls, 60-90% carboxylates, 5-15% lactones, 5-15% hydroxyacids, 0.5-7.5% diacids (dicarboxylates), and traces of other oxygenate species. However, other compositions can be produced after S230.

Heat treating the soap S250 functions to remove other carboxylate species (e.g., with greater oxidation states than carboxylic acids such as keto acids, hydroxyacids, lactones, etc. as shown for example in FIG. 3A or FIG. 3B) from the monocarboxylates (e.g., by decomposing the other carboxylate species into monocarboxylates). S250 typically results in degradation of the other carboxylate species (e.g., into CO, CO₂, H₂O, CₙHₘ, unsaturated fatty acids, etc.) where the degradation products can be recovered (e.g., when shorter chain carboxylic acids or carboxylates are formed, particularly but not exclusively when the carboxylates are saturated), can be recycled (e.g., directly into S100, indirectly into S100 such as by converting CO, CO₂, etc. into hydrocarbons, etc.), and/or can otherwise be used. In some variations, the heat treatment of the soap can be applied directly to the oxygenated hydrocarbons (e.g., without saponification).

The soap is preferably heat treated at a temperature between about 250° C. and 385° C. (e.g., 280° C., 300° C., 330° C., 350° C., 380° C., values or ranges therebetween). At temperatures below 250° C., the soaps can solidify resulting in flaking and/or otherwise complicating the soap processing (e.g., as it can require solid handling processes). At temperatures above 380° C., the monocarboxylic acids (and soaps thereof) can decarboxylate resulting in formation of paraffins or other species (rather than the desired monocarboxylic acids) and decreasing an overall yield. Moreover, variants that operate at temperatures below about 350° C. can simplify the engineering of reactors (e.g., by enabling the use of common engineering fittings rather than requiring metal on metal fittings). Similarly, variants that operate at temperatures above about 280° C. can be provide an additional advantage of tuning the rheological properties of the soap mixture (e.g., resulting in soaps with improved flowability). However, any suitable temperatures (where the soap is molten) can be used (e.g., for appropriate durations, in appropriate atmospheres, etc.).

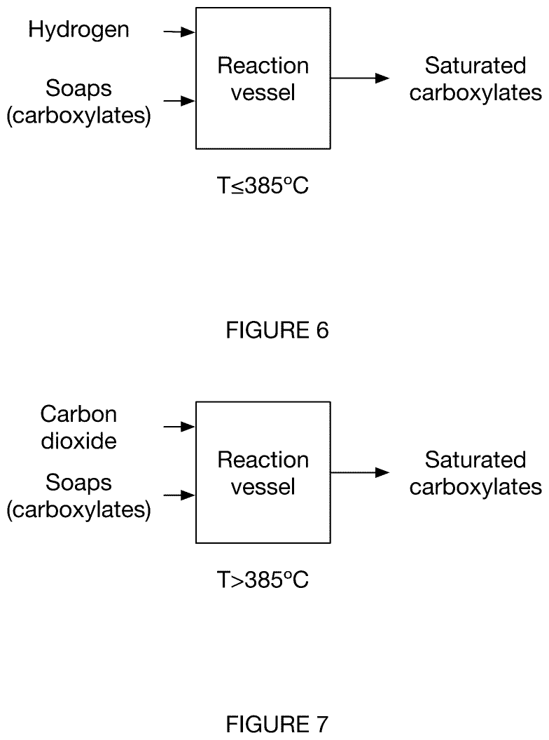

In some variants (as shown for instance in FIG. 7), the inventors have discovered that they can operate above 385° C. by introducing carbon dioxide into the reactor used for soap cooking. The inclusion of carbon dioxide is believed to suppress the decarboxylation reaction. The temperature that can be achieved in these variants is generally related to the partial pressure of carbon dioxide in the reactor. For instance, in one such example, the soap cooking could be performed at temperatures up to 425° C. with significant decarboxylation (e.g., using partial pressures of carbon dioxide up to about 10 bar). Preferably in these variants, the reaction conditions (e.g., CO₂ concentration, pressure, temperature, pH, etc.) are controlled to minimize or hinder formation of polycarboxylic acids (e.g., carboxylation of the carboxylates). In some variants, the CO₂ concentration can be tuned such that dicarboxylates (derived from diacids) undergo decarboxylation while the monocarboxylates do not substantially undergo decarboxylation, thereby further increasing the overall yield of monocarboxylic acids through the method (as diacids are converted to monocarboxylic acids).

S250 can additionally or alternatively be referred to as a dehydration step (e.g., performed in a reaction vessel, continuous stirred tank reactor, plug flow reactor, etc.), as S250 can function to dehydrate hydroxyacids, ketoacids, lactones, and/or other undesired species in the saponified sample. The dehydration step can additionally or alternatively function to remove (e.g., strip) residual organic solvent (e.g., remaining from the preceding steps) and/or residual neutral species from the soap solution. Typically, the undesired species are dehydrated into unsaturated carboxylic acids. However, the undesired species can additionally or alternatively form any suitable species (e.g., that can be separated from monocarboxylic acids).

The dehydration step is preferably performed for a dehydration duration of time between about 15 minutes and 24 hours (e.g., 30 min, 1 hour, 2 hour, 4 hour, 6 hour, 8 hours, 12 hours, 18 hours, 21 hours, etc.). However, the dehydration step can be performed for any suitable duration of time.

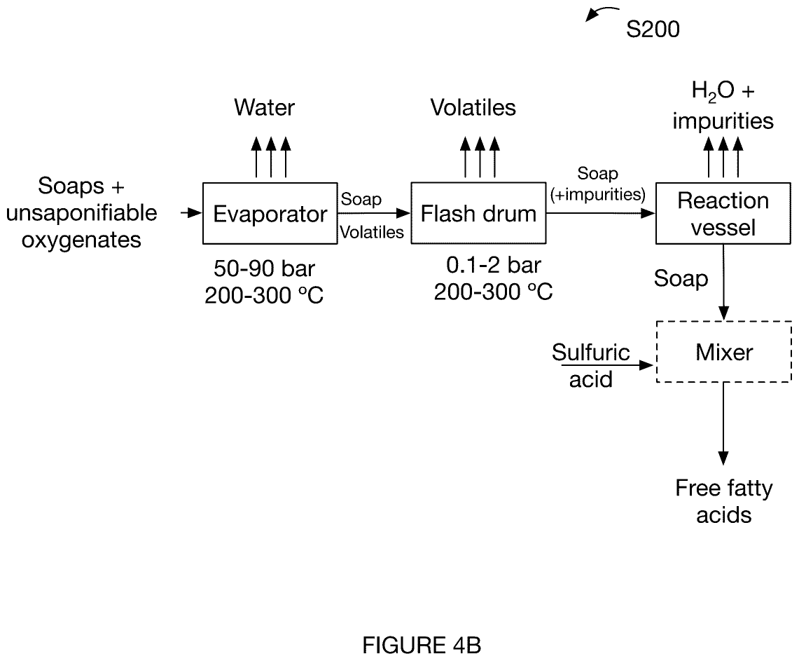

During the dehydration step, the water content of the soap sample is preferably low (e.g., <10% by weight water, <5% by weight water, <1% by weight water, etc.), which can be beneficial for driving the dehydration reaction (e.g., according to Le Chatelier's principle). However, the water content could be higher than 10% (e.g., when water is removed during the dehydration step). An exemplary plug flow reactor (e.g., fed from the bottom and aligned parallel to a gravity vector) is shown in FIG. 5. However, other suitable reactors (e.g., CSTR) and/or sample fed directions (e.g., from a side, from a top, etc.) can be used.

The dehydration step is preferably performed in an inert atmosphere (e.g., helium, neon, argon, krypton, xenon, nitrogen, etc.), which can be beneficial for removing water or volatile species remaining after evaporation step(s). However, a reactive environment can be used (e.g., to promote reaction of species to be removed from the soap sample).

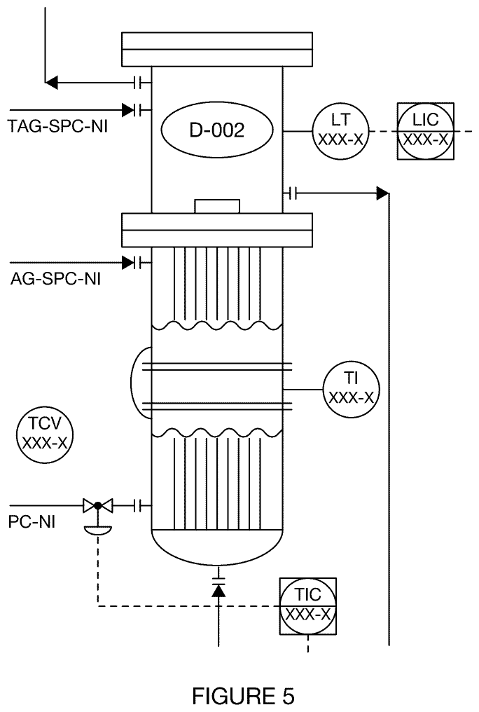

In some variations of the dehydration step (as shown for instance in FIG. 6), the environment could include hydrogen (and/or source thereof) and optionally catalyst which can function to hydrogenate unsaturated carboxylates (e.g., as they form from the dehydration reaction). As one example, the reactor (e.g., walls, surfaces, agitator, etc.) can act as the catalyst for a hydrogenation reaction. In another example, the reactor surfaces can be coated with a hydrogenation catalyst material. In another example, the hydrogenation catalyst can be suspended in solution. Exemplary catalyst materials (e.g., particles such as with characteristic size between 2 and 10000 nm, thin films, etc.) include platinum, palladium, rhodium, ruthenium, nickel, Raney nickel, Urushibara nickel, and/or other suitable catalysts can be used.

However, hydrogenation can be performed as a separate step (and/or excluded such as by separating the unsaturated and saturated fatty acids or carboxylates).

The dehydration step is preferably performed under a reduced pressure (e.g., a pressure less than atmospheric pressure), which can be beneficial for facilitating removal of residual volatile species and/or impurities or byproducts produced during soap cooking from the soap. The pressure can, for example, be 0.1 Torr, 0.5 Torr, 1 Torr, 5 Torr, 10 Torr, 50 Torr, 75 Torr, 100 Torr, 500 Torr, 700 Torr, 750 Torr, and/or values or ranges therebetween. However, the pressure can be any suitable pressure (e.g., elevated pressure such as to influence a reaction equilibrium). In some variations, the reduced pressure step can be included in isolation from the dehydration step (e.g., as a separate additional or alternative step).

After S250, a hydroxyl value (i.e., measured hydroxyl groups exclusive of carboxyl groups such as measured by titrating the sample with potassium hydroxide and correcting the measurement based on a measure of the acid value of the sample) of the soap (and/or fatty acids) is preferably less than about 1. Additionally or alternatively, after S250, an ester value (i.e., difference between saponification value and acid value) of the soap (and/or fatty acids) is preferably less than about 1. However, the sample can have any suitable hydroxyl value and/or ester value.

After S250, the dehydrated species are preferably converted into saturated monocarboxylic acids, which can provide a technical benefit of increasing a yield of fatty acids from the oxidation of hydrocarbons (e.g., producing more usable fat species for the formation of fat formulations). In some variants, the dehydrated species could remain unsaturated (preferably, but not exclusively, for unsaturated species with cis-double bonds). In one illustrative example (as shown for instance in FIG. 3C), after S250, a saponified sample can have an organic composition that is ≤5% hydrocarbons, ≤1% fatty alcohols, ≤1% fatty carbonyls, ≥90% carboxylates (e.g., monocarboxylic fatty acids), ≤1% lactones, ≤1% hydroxyacids, ≤1% diacids, and ≤1% other oxygenate species. However, after S250, the saponified sample can have other compositions.

In variants that include a mixing step, the mixing step preferably functions to form an aqueous solution of the soap, which can be beneficial for downstream handling, transport, processing, etc. of the soap. The mixing step is preferably performed under pressure (e.g., to enable water to be heated to above its boiling point at standard pressure). For example, the mixing step can be performed at 90 Bar (where the boiling point of water is approximately 300° C.). In this example, the soap is preferably cooled (e.g., to about 300° C.) prior to adding water (e.g., to minimize the formation of steam formed by contacting the water with the molten soap). Other pressures and/or temperatures can be used (e.g., preferably pressures that enable temperature greater than about 250° C. such as pressures greater than about 40 Bar). The soap is preferably dissolved to an approximately 40% (e.g., by weight such as 20-45%) solution in water (e.g., 40 g soap/100 g water+soap). This concentration is preferred as higher concentrations have poor rheological properties (e.g., harder to pump, transport, etc.) and high melting points (e.g., requiring higher temperatures to maintain the soap as a liquid for transport, potentially resulting in solid formation within the soap cooker components, etc.), while lower concentrations can have unnecessary water usage. However, other concentrations can be used (e.g., greater than 30% or less than 30%). The mixing step can use (for instance) an agitating mixer (e.g., spiral mixer) and/or a static mixer (e.g., plate-type, flow division, radial mixing, etc., where a static mixer can be beneficial for ease of sealing while maintaining pressure) to promote mixing (e.g., formation of a homogeneous mixture) of the soap and water. However, any suitable mixer can be used.

Acidulating the soap S280 functions to convert the carboxylates back to carboxylic acids. Acidulating the soap typically takes place after (e.g., separate from) S250. However, S280 can be included as a portion of S250 (e.g., as a final step within S250, concurrently with a mixing step or redissolving the soap in water). S280 can be performed as a continuous or batch process. Acidulating the soap can include neutralizing the soap with acid (e.g., hydrochloric acid, hydrobromic acid, hydroiodic acid, sulfuric acid, nitric acid, phosphoric acid, etc. such as a stoichiometric amount of acid, an excess of acid, etc.). However, S280 can include any suitable step(s).

In some variants, the dissolution step (e.g., mixing step) can be performed contemporaneously with acidulating the soap (e.g., from S250). In other words, the saponified sample can be diluted using one or more acids thereby also resulting in reacidulation of the carboxylates. In these variants, the acidulation can result in excess heat generation, therefore a cooled reactor can be beneficial and/or care can otherwise be taken to minimize heat generation in the reactor.

Fractioning the separated carboxylic acids S300 functions to separate carboxylic acids of different chain lengths. Fractioning the separated carboxylic acids can additionally or alternatively function to improve a separation of the carboxylic acids (e.g., remove residual oxygenated hydrocarbon species in the carboxylic acid sample prepared in S200) and/or can otherwise function.

The carboxylic acid (and/or other oxygenated hydrocarbons) can be fractionated using fractional distillation (e.g., short path distillation), using solvents (e.g., supercritical fluid fractionation, solvent fractionation such as using a solvent or solvent combination from solvents as described above, etc.), crystallization (e.g., static crystallization), using an evaporation process (e.g., falling-film evaporation, wiped film evaporation, etc.), winterization, using one or more separation technique (e.g., as described in S200), and/or in any manner.

The carboxylic acids are preferably fractioned into narrow band fractions (e.g., predominantly a single chain length, predominantly 2 chain lengths such as an even chain length and an odd chain length immediately larger than the even chain length, etc.), but can be fractioned into broad band fractions (e.g., fractions that include greater than 3 chain lengths), into nonsequential fractions (e.g., separate even chain length fractions, odd chain length fractions, etc.), and/or can be separated into any suitable fractions. As an illustrative example, a carboxylic acid sample can be fractioned into a short chain (e.g., shorter than 8 carbon atoms) fraction, a C8 and C9 fraction, a C10 and C11 fraction, a C12 and C13 fraction, a C14 and C15 fraction, a C16 and C17 fraction, a C18 and C19 fraction, a C20 and C21 fraction, a C22 and C23 fraction, and/or a long chain fraction (e.g., longer than 23 carbon atoms in the chain), where C# refers to a number of carbon atoms in the carboxylic acid. However, a carboxylic acid sample can be fractioned into any suitable samples.

A composition of a fraction is preferably at least about 90% (e.g., by weight, by volume, stoichiometric percent, etc. such as 85%, 87%, 90%, 92%, 95%, 97.5%, 98%, 99%, 99.5%, 99.9%, 99.99%, 99.995%, 99.999%, 99.9999%, etc.) carboxylic acids with target chain lengths, but can include less than 90% of the target carboxylic acids.

In some variants, fractionation (and/or separation) can be performed in a manner as described in U.S. patent application Ser. No. 18/807,247 titled ‘SYSTEM AND METHOD FOR TRIGLYCERIDE MANUFACTURE’ filed 16 Aug. 2024 which is incorporated in its entirety by this reference.

Esterifying the oxygenated hydrocarbons S400 preferably functions to form glycerides, but can additionally or alternatively form any suitable esters of the oxygenated hydrocarbons. Fatty acids (e.g., carboxylic acids) are preferably esterified with glycerol. However, additionally or alternatively, alcohols and/or any suitable oxygenated hydrocarbons can be esterified. The glycerides are preferably triglycerides, but can additionally or alternatively be (or include) di-glycerides (e.g., 1,2-diglycerides, 1,3-diglycerides) and/or monoglycerides (e.g., 1-monoglycerides, 2-monoglycerides). The polyglycerides (e.g., diglycerides, triglycerides) can be homoglycerides (e.g., include a plurality of the same fatty acid moiety, homotriglycerides, homodiglycerides, etc.) or heteroglycerides (e.g., include two or three different fatty acid moieties, heterotriglycerides, etc.).

One or more carboxylic acid fraction can be esterified together. When multiple fractions are esterified together, the different carboxylic acid fractions can be coesterified (e.g., a first fatty acid fraction and a second fatty acid fraction can be combined and the resulting combination can undergo an esterification reaction), the different carboxylic acid fractions can be interesterified (e.g., each fraction can be esterified separately, the resulting esters can be mixed, and the resulting esters can undergo interesterification), and/or the carboxylic acid fractions can otherwise be esterified (e.g., a combination of coesterification and interesterification can be used).

In variants when more than one fraction is esterified together, interesterification is preferably used. Before interesterification, the esters (e.g., esters associated with each of the fractions to be interesterified) are preferably deodorized (e.g., as described in S500, in a different manner, etc.). Despite adding additional steps to the processing (e.g., adding at least one additional purification step for each ester compared with coesterification), the resulting process can be cleaner (e.g., lower energy, lower carbon impact, etc.) than coesterification. However, additionally or alternatively, coesterification can be cleaner than interesterification (e.g., because the fractions were cleaner after oxidation in S100, separation in S200, fractionation in S300, etc.; because fewer samples need to be treated; etc.).

The fatty acids can be esterified (and/or coesterified, interesterified, etc.) using Fischer esterification (e.g., treating the carboxylate with an alcohol in the presence of a dehydrating agent preferably in acidic conditions), Steglich esterification, Mitsunobu reaction, using epoxides, using alcoholysis (e.g., converting the fatty acid to an acyl halide or acid anhydride which is reacted with an alcohol), alkylation of carboxylate anions (e.g., reacting carboxylates of the fatty acid such as generated using a base with an alkyl halide), using the Tishchenko reaction (e.g., to convert recovered aldehydes into esters), interesterifcation (e.g., between glycerides of different fatty acids), and/or using any suitable methods (e.g., uncatalyzed esterification). The esterification can be acid catalyzed, base catalyzed, uncatalyzed, and/or catalyzed in any manner.

Fractions that are not used in forming an ester sample can be retained (e.g., to be used in a subsequent batch to form esters), used in other processes, provided as a potential carbon feedstock (e.g., to be reduced, converted into a paraffin, etc.), can have their chain length modified (e.g., reduce or increase a chain length so that the fraction aligns to another fraction's chain length), and/or can otherwise be used and/or discarded.

Deodorizing the esters S500 preferably functions to purify the esters such as to remove residual free fatty acids, residual oxygenated hydrocarbons (e.g., that were not removed in S200 or S300), odorants, flavorants, and/or other chemical species (e.g., low molecular weight glycerides such as diglycerides, monoglycerides, triacylglycerides with a low molecular weight within a distribution of triacylglycerides, etc.) that can impact a property of the glyceride and/or ester formulation. In some variants, deodorizing esters can also be referred to a refining the esters, which can function to remove bulk free fatty acids (and may also result in removal of esters, particularly, but not exclusively, low molecular weight triacylglycerides within a distribution of triacylglycerides). S500 is typically performed after S400, but could be performed after S200 and/or S300 (e.g., to purify or deodorize the free carboxylic acids) and/or with any suitable timing.

The ester(s) are preferably deodorized using thermal distillation (e.g., steam distillation, steam stripping, etc.). However, the ester(s) can additionally or alternatively be deodorized using any suitable separation process (e.g., as described in S200), fractionation process (e.g., as described in S300), and/or using any suitable process(es).

An ester recovery (e.g., glyceride recovery such as an amount of ester recovered from the amount of ester input) from the deodorization is preferably greater than about 75% (e.g., 80%, 85%, 90%, 95%, 97%, 99%, 99.5%, etc.). However, deodorization can result in any suitable ester recovery. The impurity concentration of the ester(s) (e.g., the concentration of other oxygenated species that are not fatty acid esters such as triacylglycerides, diacylglycerides, etc.) after deodorization is preferably less than about 5% (e.g., 0.001%, 0.01%, 0.05%, 0.1%, 0.5%, 1%, 2%, 5%, etc. where the percentage can refer to a weight percentage, mass percentage, volume percentage, stoichiometric percentage, etc.). However, any suitable impurity concentration can remain in the ester(s).

In some variants, the method can include a hydrogenation step (e.g., to convert unsaturated fatty acids, esters, etc. into their saturated analogues). The hydrogenation can be performed on soaps, free fatty acids, esters, and/or other suitable species (e.g., during or after S100, S200, S300, S400, and/or S500).

In an illustrative example of the method (as shown for instance in FIG. 2), a paraffin sample (e.g., primarily, exclusively, etc. unbranched alkanes) can be oxidized to form oxygenated hydrocarbons; fatty acids (e.g., monocarboxylic acids) can be separated from (e.g., recovered) the oxygenated hydrocarbons using saponification, where the soaps are heat-treated and/or cooked (prior to reacidulation) to remove unreacted hydrocarbons and/or oxygenated hydrocarbons other than monocarboxylic acids; the fatty acids can be fractionated into substantially pairwise chain lengths of fatty acids (e.g., where the pairs include an even chain length and a chain length with one carbon more such as C8 and C9 in a single fraction); two or more fractions can be combined (e.g., mixed) and coesterified to form triglycerides, and the triglycerides can optionally be purified by deodorization (e.g., to remove free fatty acids).

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30%, etc. of a reference), or be otherwise interpreted.

As a person skilled in the art will recognize from the previous detailed description and from the figures and claims, modifications and changes can be made to the preferred embodiments of the invention without departing from the scope of this invention defined in the following claims.

### 4. Specific Examples

A numbered list of specific examples of the technology described herein are provided below. A person of skill in the art will recognize that the scope of the technology is not limited to and/or by these specific examples.
1. A method comprising: oxidizing hydrocarbons to form a mixture of oxygenates comprising fatty alcohols, aldehydes, ketones, monocarboxylic acids, hydroxyacids, lactones, and unreacted hydrocarbons; saponifying the mixture of oxygenates to generate saponifiable species from the monocarboxylic acids, the hydroxyacids, and the lactones and nonsaponifiable species from the unreacted hydrocarbons, the fatty alcohols, the aldehydes, and the ketones; at a first pressure greater than 50 barg and a first temperature between 20° and 300° C., evaporatively removing solvent from the saponifiable species and the nonsaponifiable species; at a second pressure between 0.5 and 2 barg and a second temperature between 20° and 300° C., evaporatively removing residual solvent remaining after c) and volatile nonsaponifiable species; thermally treating the saponifiable species to convert the hydroxyacids and the lactones into unsaturated monocarboxylic acids; hydrogenating the unsaturated monocarboxylic acids to form saturated monocarboxylates; and neutralizing the saponifiable species and the saturated monocarboxylates.
2. The method of Specific Example 1, wherein throughout steps c) through g), the saponifiable species are retained at a temperature greater than a saponifiable species melting temperature.
3. The method of any of Specific Examples 1 or 2, wherein e) is performed at a third temperature less than 380° C.
4. The method of any of Specific Examples 1-3, wherein the volatile nonsaponifiable species from d) are captured and oxidized in step a).
5. The method of any of Specific Examples 1-4, wherein a residence time of species in e) is between 30 minutes and 4 hours.
6. The method of any of Specific Examples 1-5, wherein c) is performed until the first pressure decreases by at least 5 barg.
7. A method for increasing a yield of monocarboxylic acids formed via oxidation of hydrocarbons comprising: saponifying oxygenates formed by the oxidation of hydrocarbons to produce a saponified sample (e.g., a mixture of saponified organic species and unsaponified or unsaponifiable organic species); optionally washing the saponified sample (e.g., using a solvent such as water, ethanol, hexane, etc.) to form a saponified phase (e.g., carboxylates or carboxylate salts such as formed from fatty acids, lactones, hydroxyacids, diacids, etc.) and an unsaponified phase (e.g., neutral species such as hydrocarbons, fatty alcohols, fatty carbonyls, water, ethanol, hexane, etc.) where the unsaponified phase can be decanted (or otherwise physically removed) from the saponified phase; heat treating the saponified sample (or saponified phase) within a reaction vessel at a temperature between 200° C. and 385° C., wherein the saponified sample (or saponified phase) comprises hydroxyacids and lactones, wherein the hydroxyacids and the lactones are converted to unsaturated carboxylates during the heat treatment; while the reaction vessel is between 200° C. and 385° C., introducing hydrogen gas into the reaction vessel to reduce unsaturated bonds of the unsaturated carboxylates to saturated bonds forming saturated carboxylates; and neutralizing the saturated carboxylates to form the monocarboxylic acids. In some variations of this specific example, the unsaturated bonds are not reduced until after the carboxylates have been neutralized.
8. The method of Specific Example 7, wherein the saponified sample (or saponified phase) comprises neutral oxygenates and carboxylates.
9. The method of Specific Example 8, further comprising, prior to heat treating the saponified sample (or saponified phase), performing a multi-stage evaporation to remove solvent and neutral oxygenates that are volatile from the carboxylates.
10. The method of Specific Example 9, wherein the multi-stage evaporation comprises: at a pressure greater than about 30 bar, evaporating water from the saponified sample (or saponified phase); and flash evaporating neutral oxygenates, residual water remaining after evaporating the water from the saponified sample (or saponified phase), and residual hydrocarbons remaining after the oxidation of the hydrocarbons.
11. The method of any of Specific Examples 9 or 10, wherein the neutral oxygenates and residual hydrocarbons are captured and oxidized to produce a second oxygenate sample, wherein the second oxygenate sample is processed in the same manner as the oxygenates.
12. The method of any of Specific Examples 7-11, wherein before neutralizing the saturated carboxylates, the saturated carboxylates are dissolved in water at a temperature wherein the saturated carboxylates do not solidify.
13. The method of any of Specific Examples 7-12, wherein surfaces of the reaction vessel act as a catalyst for reducing the unsaturated bonds of the unsaturated carboxylates to saturated bonds.
14. A method for removing contaminants from a mixture of oxygenates comprising: saponifying oxygenates formed by the oxidation of hydrocarbons to produce a saponified sample (e.g., a mixture of saponified organic species and unsaponified or unsaponifiable organic species); optionally washing the saponified sample (e.g., using a solvent such as water, ethanol, hexane, etc.) to form a saponified phase (e.g., carboxylates or carboxylate salts such as formed from fatty acids, lactones, hydroxyacids, diacids, etc.) and an unsaponified phase (e.g., neutral species such as hydrocarbons, fatty alcohols, fatty carbonyls, water, ethanol, hexane, etc.) where the unsaponified phase can be decanted (or otherwise physically removed or separated) from the saponified phase; heat treating the saponified sample (or the saponified phase) within a reaction vessel at a temperature between 350° C. and 425° C., wherein the saponified sample (or the saponified phase) comprises hydroxyacids and lactones, wherein the hydroxyacids and the lactones are converted to unsaturated carboxylates during the heat treatment; when a temperature of the reaction vessel is greater than about 375° C., carbon dioxide is introduced into the reaction vessel to reduce a rate of a decarboxylation reaction; transferring the unsaturated carboxylates to a second reaction vessel, wherein in the second reaction vessel the unsaturated carboxylates are hydrogenated to form saturated carboxylates; and neutralizing the saturated carboxylates to form the monocarboxylic acids.
15 The method of Specific Example 14, wherein the saponified sample (or the saponified phase) comprises neutral oxygenates (e.g., unsaponified material) and carboxylates.
16. The method of Specific Example 15, further comprising, prior to heat treating the saponified sample (or the saponified phase), performing a multi-stage evaporation to remove solvent and neutral oxygenates that are volatile from the carboxylates.
17. The method of Specific Example 16, wherein the multi-stage evaporation comprises: at a pressure greater than about 30 bar, evaporating water from the saponified sample (or the saponified phase); and flash evaporating neutral oxygenates, residual water remaining after evaporating the water from the saponified sample (or the saponified phase), and residual hydrocarbons remaining after the oxidation of the hydrocarbons.
18. The method of either Specific Example 16 or 17, wherein the neutral oxygenates and residual hydrocarbons are captured and oxidized to produce a second oxygenate sample, wherein the second oxygenate sample is processed in the same manner as the oxygenates.
19. The method of any of Specific Examples 1-18, wherein a composition of the saponified sample (or the saponified phase), excluding the solvent, comprises between 20% and 40% by mass oxygenates and 60-80% by mass hydrocarbons; wherein the oxygenates further comprise: fatty alcohols, ketones, fatty aldehydes, and fatty acids; wherein substantially all of the fatty alcohols, ketones, fatty aldehydes, and hydrocarbons are not saponified and are separated from the saponifiable sample prior to heat treating the saponifiable sample.
20. The method of Specific Example 19, wherein the oxygenates consist essentially of saturated oxygenates.

We claim:

1. A method comprising:
a) oxidizing hydrocarbons to form a mixture of oxygenates comprising fatty alcohols, aldehydes, ketones, monocarboxylic acids, hydroxyacids, lactones, and unreacted hydrocarbons;
b) saponifying the mixture of oxygenates to generate saponifiable species from the monocarboxylic acids, the hydroxyacids, and the lactones and nonsaponifiable species from the unreacted hydrocarbons, the fatty alcohols, the aldehydes, and the ketones;
c) at a first pressure greater than 50 barg and a first temperature between 20° and 300° C., evaporatively removing solvent from the saponifiable species and the nonsaponifiable species;
d) at a second pressure between 0.5 and 2 barg and a second temperature between 20° and 300° C., evaporatively removing residual solvent remaining after c) and volatile nonsaponifiable species;
e) thermally treating the saponifiable species to convert the hydroxyacids and the lactones into unsaturated monocarboxylic acids;
f) hydrogenating the unsaturated monocarboxylic acids to form saturated monocarboxylates; and
g) neutralizing the saponifiable species and the saturated monocarboxylates.

2. The method of claim 1, wherein throughout steps c) through g), the saponifiable species are retained at a temperature greater than a saponifiable species melting temperature.

3. The method of claim 1, wherein e) is performed at a third temperature less than 380° C.

4. The method of claim 1, wherein the volatile nonsaponifiable species from d) are captured and oxidized in step a).

5. The method of claim 1, wherein a residence time of species in e) is between 30 minutes and 4 hours.

6. The method of claim 1, wherein c) is performed until the first pressure decreases by at least 5 barg.

7. A method for increasing a yield of monocarboxylic acids formed via oxidation of hydrocarbons comprising:
saponifying oxygenates formed by the oxidation of hydrocarbons to produce a saponified sample;
heat treating the saponified sample within a reaction vessel at a temperature between 200° C. and 385° C., wherein the saponified sample comprises hydroxyacids and lactones, wherein the hydroxyacids and the lactones are converted to unsaturated carboxylates during the heat treatment;
while the reaction vessel is between 200° C. and 385° C., introducing hydrogen gas into the reaction vessel to reduce unsaturated bonds of the unsaturated carboxylates to saturated bonds forming saturated carboxylates; and
neutralizing the saturated carboxylates to form the monocarboxylic acids.

8. The method of claim 7, wherein the saponified sample comprises neutral oxygenates and carboxylates.

9. The method of claim 8, further comprising, prior to heat treating the saponified sample, performing a multi-stage evaporation to remove solvent and neutral oxygenates that are volatile from the carboxylates.

10. The method of claim 9, wherein the multi-stage evaporation comprises:
at a pressure greater than about 30 bar, evaporating water from the saponified sample; and
flash evaporating neutral oxygenates, residual water remaining after evaporating the water from the saponified sample, and residual hydrocarbons remaining after the oxidation of the hydrocarbons.

11. The method of claim 9, wherein the neutral oxygenates and residual hydrocarbons are captured and oxidized to produce a second oxygenate sample, wherein the second oxygenate sample is processed in the same manner as the oxygenates.

12. The method of claim 7, wherein before neutralizing the saturated carboxylates, the saturated carboxylates are dissolved in water at a temperature wherein the saturated carboxylates do not solidify.

13. The method of claim 7, wherein surfaces of the reaction vessel act as a catalyst for reducing the unsaturated bonds of the unsaturated carboxylates to saturated bonds.

14. A method for removing contaminants from a mixture of oxygenates comprising:
saponifying oxygenates formed by the oxidation of hydrocarbons to produce a saponified sample;
heat treating the saponified sample within a reaction vessel at a temperature between 350° C. and 425° C., wherein the saponified sample comprises hydroxyacids and lactones, wherein the hydroxyacids and the lactones are converted to unsaturated carboxylates during the heat treatment;
when a temperature of the reaction vessel is greater than about 375° C., carbon dioxide is introduced into the reaction vessel to reduce a rate of a decarboxylation reaction;
transferring the unsaturated carboxylates to a second reaction vessel, wherein in the second reaction vessel the unsaturated carboxylates are hydrogenated to form saturated carboxylates; and
neutralizing the saturated carboxylates to form the monocarboxylic acids.

15. The method of claim 14, wherein the saponified sample comprises neutral oxygenates and carboxylates.

16. The method of claim 15, further comprising, prior to heat treating the saponified sample, performing a multi-stage evaporation to remove solvent and neutral oxygenates that are volatile from the carboxylates.

17. The method of claim 16, wherein the multi-stage evaporation comprises:
at a pressure greater than about 30 bar, evaporating water from the saponified sample; and
flash evaporating neutral oxygenates, residual water remaining after evaporating the water from the saponified sample, and residual hydrocarbons remaining after the oxidation of the hydrocarbons.

18. The method of claim 16, wherein the neutral oxygenates and residual hydrocarbons are captured and oxidized to produce a second oxygenate sample, wherein the second oxygenate sample is processed in the same manner as the oxygenates.

19. The method of claim 14, wherein a composition of the saponified sample, excluding the solvent, comprises between 20% and 40% by mass oxygenates and 60-80% by mass hydrocarbons; wherein the oxygenates further comprise: fatty alcohols, ketones, fatty aldehydes, and fatty acids; wherein substantially all of the fatty alcohols, ketones, fatty aldehydes, and hydrocarbons are not saponified and are separated from the saponifiable sample prior to heat treating the saponifiable sample.

20. The method of claim 19, wherein the oxygenates consist essentially of saturated oxygenates.
